(19) United States
(12) Patent Application Publication
(10) Pub. No.: US 2025/0284154 A1
(43) Pub. Date: Sep. 11, 2025

(54) CHROMA AND TRANSPARENT MODULABLE DISPLAY

(71) Applicant: AUO Display Plus Corporation, Hsinchu City (TW)

(72) Inventors: Yu-Chien Tseng, Hsinchu City (TW); Hui-Lung Lu, Hsinchu City (TW)

(21) Appl. No.: 18/676,544

(22) Filed: May 29, 2024

(30) Foreign Application Priority Data
Mar. 7, 2024 (TW) 113108470

(51) Int. Cl. G02F 1/13; G02F 1/1334; G02F 1/13357; G02F 1/1339

(52) U.S. Cl. CPC G02F 1/1326; G02F 1/13306; G02F 1/13345; G02F 1/133603; G02F 1/13394

(57) ABSTRACT

A modulable transparent display includes a liquid crystal display (LCD) panel, a light modulation module, and a control module. The light modulation module has a brightness and a transparency. The control module is electrically connected to the LCD panel and the light modulation module. The control module includes a first control unit and a second control unit. The first control unit is adapted to provide a display signal for the LCD panel, and the second control unit is adapted to provide a control signal for the light modulation module to control the brightness and the transparency of the light modulation module.

### CROSS-REFERENCE TO RELATED APPLICATION

This non-provisional application claims priority under 35 U.S.C. § 119 (a) to patent application No. 113108470 filed in Taiwan, R.O.C. on Mar. 7, 2024, the entire contents of which are hereby incorporated by reference.

### BACKGROUND

### Technical Field

The instant disclosure is related to the field of display, especially to a modulable transparent display.

### Related Art

A transparent display may be provided on the glass of a vehicle or a shop window. Therefore, upon the transparent display demonstrates important information, physical objects behind the transparent display can still be seen, thereby allowing the user to have better visual experiences.

A transparent display known to the inventor is an organic light-emitting diode (OLED)-based display, and arranged a transparent region in the pixel arrangement. Furthermore, through the flexibility, the display can be configured to be curved and thin.

However, the practical issues of the OLED transparent display lie on the cost and the durability. The cost for OLEDs is much expensive while the durability of the OLEDs is shorter. As a result, in the case that the OLED transparent display is applied to be the display on the shop windows or the vehicles, the OLED transparent display cannot satisfy the durability requirement. Moreover, the OLED transparent display cannot be adjusted to be transparent or non-transparent, thus limiting the application fields and the display functions of the display.

### SUMMARY

Liquid crystal display (LCD) panels are matured products and have been developed for many years. The inventors encounter some issues upon using the LCD panels to manufacture a transparent display. As compared with a light-emitting diodes (LED), though the LCD panel can be configured transparent upon merely relying on ambient light (no built-in light source), the LCD panel has issues such as the brightness of the screen is darker, the image on the screen is less colorful, and the application fields of the LCD panel is limited.

For the structure of an LCD device known to the inventor, upon the backplane and the reflection plate are removed while the light source and the light guiding plate are retained, though the brightness of the LCD can be effectively increased, optical structures (for example, prism structures or diffusion structures) of the light guiding plate for performing light guiding function causes that ripples or incomplete bright spots can be seen on the screen through experiments.

To address these issues, a modulable transparent display is provided. In some embodiments, a modulable transparent display comprises a liquid crystal display (LCD) panel, a light modulation module, and a control module. The light modulation module has a brightness and a transparency. The control module is electrically connected to the LCD panel and the light modulation module. The control module comprises a first control unit and a second control unit. The first control unit is adapted to provide a display signal for the LCD panel, and the second control unit is adapted to provide a control signal for the light modulation module to control the brightness and the transparency of the light modulation module. Accordingly, through the configuration of the light modulation module and the control module, the user can freely choose the display mode to be displayed on the modulable transparency display.

In some embodiments, the modulable transparency display further comprises a spacer. The spacer is between the light modulation module and the LCD panel, and a gap is maintained through the spacer.

In some embodiments, the light modulation module comprises a transparent substrate and a light-emitting array on the transparent substrate.

Specifically, in some embodiments, the light-emitting array comprises one of an organic light-emitting diode (OLED) array, a mini light-emitting diode (LED) array, or a micro LED array.

Specifically, in some embodiments, the light-emitting array is defined as a plurality of control regions, and each of the control regions is controlled by the second control unit.

Specifically, in some embodiments, the light modulation module comprises a light source, a light guiding plate, and a light modulation unit, the light source is at a side edge of the light guiding plate, the light guiding plate is between the light modulation unit and the LCD panel to guide a light emitted from the light source toward the LCD panel, and the light modulation unit and the light source are controlled by the second control unit, respectively.

Furthermore, in some embodiments, a size of the gap is at least greater than 20 mm. Moreover, in some embodiments, the size of the gap is in a range between 20 mm and 50 mm.

Specifically, in some embodiments, the spacer is assembled with a side edge of the LCD panel and the side edge of the light guiding plate.

Specifically, in some embodiments, the spacer comprises a first assembling portion and a second assembling portion, the first assembling portion is assembled with the side edge of the light guiding plate to shield the light source, the second assembling portion extends form one of two ends of the first assembling portion along a direction substantially perpendicular to an extension direction of the first assembling portion, and the second assembling portion is assembled with a side edge of the LCD panel.

Furthermore, in some embodiments, the spacer further comprises a third assembling portion, the third assembling portion and the second assembling portion respectively extend from the two ends of the first assembling portion, the third assembling portion is substantially parallel to the second assembling portion, and the third assembling portion contacts an edge portion of a bottom portion of the light guiding plate.

Specifically, in some embodiments, the light modulation unit comprises a liquid crystal layer and a transparent conductive layer, and the second control unit is electrically connected to the transparent conductive layer to control a liquid crystal rotation angle of the liquid crystal layer.

Furthermore, in some embodiments, the liquid crystal layer is a polymer-dispersed liquid crystal (PDLC) layer or a polymer network liquid crystal (PNLC) layer.

Furthermore, in some embodiments, the transparent conductive layer is divided into a plurality of control regions, and each of the control regions is controlled by the second control unit.

Moreover, in some embodiments, the control regions are of a strip arrangement, a grid arrangement, or a concentric arrangement.

According to one or some embodiments, by using the LCD panel which adopts more matured manufacturing processes and has cheaper prices in the modulable transparent display, not only the costs of the display can be greatly reduced and the duration of the display can be increased, but also, through the configuration of the light modulation module, the display scenario of the LCD panel can be modulated. According to some embodiments, an additional light source may be provided for the LCD panel to address the issue of insufficient lightening of the LCD panel under ambient light, and according to some other embodiments, the LCD panel may be switched to a non-transparent mode to increase the display performance. Hence, the user can select and control the operation mode of the display according to the application scenarios, thereby allowing the display to provide various applications.

### BRIEF DESCRIPTION OF THE DRAWINGS

The disclosure will become more fully understood from the detailed description given herein below for illustration only, and thus not limitative of the disclosure, wherein:

FIG. 1 illustrates a cross-sectional view of a modulable transparent display according to a first embodiment of the instant disclosure;

FIG. 2 illustrates a block diagram of the modulable transparent display;

FIG. 3 illustrates a cross-sectional view of a modulable transparent display according to a second embodiment of the instant disclosure;

FIG. 4 illustrates a cross-sectional view of a modulable transparent display according to a third embodiment of the instant disclosure;

FIG. 5 illustrates an enlarged cross-sectional view of a light modulation unit according to one embodiment of the instant disclosure;

FIG. 6A to FIG. 6D illustrate schematic views of controlled regions of various embodiments of the instant disclosure;

FIG. 7 illustrates a cross-sectional view of a modulable transparent display according to a fourth embodiment of the instant disclosure;

FIG. 8 illustrates an enlarged cross-sectional view of a light modulation module according to one embodiment of the instant disclosure;

FIG. 9 illustrates a cross-sectional view of a modulable transparent display according to a fifth embodiment of the instant disclosure;

FIG. 10 illustrates a cross-sectional view of a modulable transparent display according to a sixth embodiment of the instant disclosure;

FIG. 11 illustrates an enlarged cross-sectional view of a light modulation module according to another embodiment of the instant disclosure; and

FIG. 12 illustrates a cross-sectional view of a modulable transparent display according to a seventh embodiment of the instant disclosure.

### DETAILED DESCRIPTION

It should be understood that, when an element is referred to as being “disposed on” another element, the element may be directly on the another element, or one or more intervening elements may be present so that the element is connected to the another element through the one or more intervening elements. On the contrary, when an element is referred to as being “directly disposed on” or “directly disposed to” another element, it can be clearly understood that there are no intervening elements between the two elements.

Furthermore, in the following descriptions, it will be understood that, although the terms “first,” “second,” “third,” etc. may be used herein to describe various elements, components, regions, layers, or sections, these terms are only used to distinguish these elements, components, regions, layers, or sections, rather than are used to represent the definite order of these elements, components, regions, layers, or sections. Moreover, spatially relative terms, such as “beneath,” “below,” “lower,” “above,” “upper,” and the like, may be used herein for ease of description to describe one element or feature's relationship to another element(s) or feature(s) as illustrated in the drawings. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. In other words, these terms only represent a relative position relationship between the described components, not an absolute position relationship between the described components.

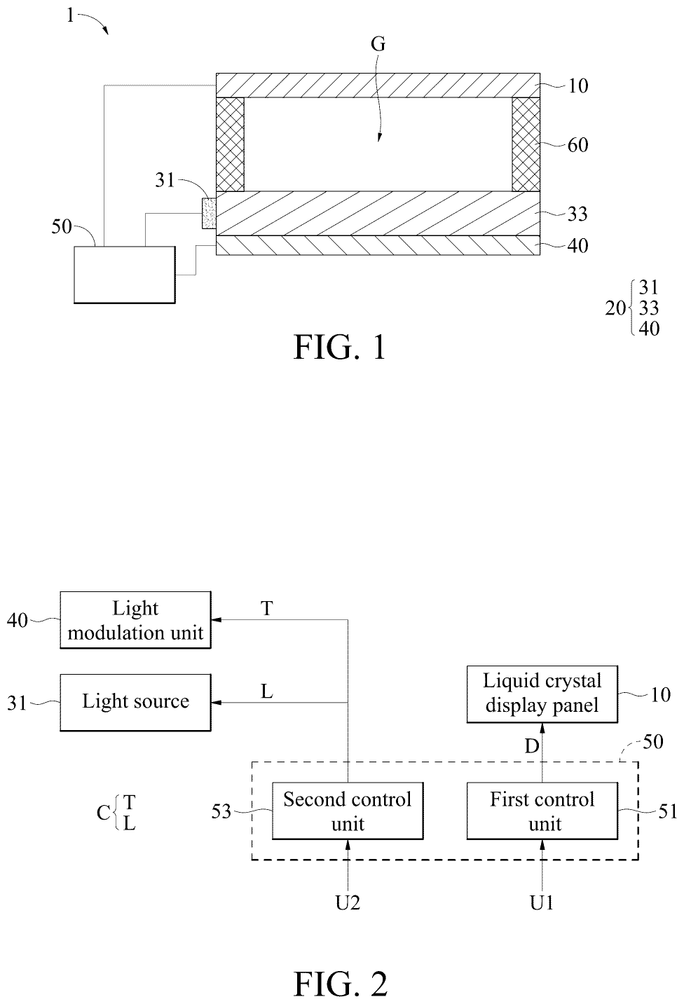

FIG. 1 illustrates a cross-sectional view of a modulable transparent display according to a first embodiment of the instant disclosure. FIG. 2 illustrates a block diagram of the modulable transparent display. As shown in FIG. 1 and FIG. 2, in some embodiments, the modulable transparent display 1 comprises a liquid crystal display (LCD) panel 10, a light modulation module 20, and a control module 50. The light modulation module 20 has a brightness and a transparency. The control module 50 is electrically connected to the LCD panel 10 and the light modulation module 20, and the control module 50 comprises a first control unit 51 and a second unit 53. The first control unit 51 is adapted to provide a display signal D for the LCD panel 10, and the second control unit 53 is adapted to provide a control signal C for the light modulation module 20. The control signal comprises a brightness signal L and a transparency modulation signal T which respectively control the brightness and the transparency of the light modulation module 20.

More specifically, in some embodiments, the light modulation module 20 comprises a light source 31, a light guiding plate 33, and a light modulation unit 40. The light guiding plate 33 is between the light modulation unit 40 and the LCD panel 10 to guide a light emitted from the light source toward the LCD panel 31. In this embodiment, in order to reduce the thickness of the modulable transparent display 1 in combination with the consideration of adopting ambient lights, the modulable transparent display 1 is of a lateral-lighting configuration. In this embodiment, the modulable transparent display 1 further comprises a spacer 60 to maintain a gap G between the light guiding plate 33 and the LCD panel 10. In this embodiment, through experimentations, the inventor found that the compactness of the optical microstructures (such as the prism patterns) on the light guiding plate 33 for guiding the light from the side portion of the light guiding plate 33 toward the LCD panel 10 is related to the ripple patterns. And, the Inventor found that, by using the spacer 60 to maintain the gap G between the light guiding plate 33 and the LCD panel 10, such issue can be effectively addressed. In general, the inventor found that when the size of the gap G is equal to or greater than 20 mm, the ripple patterns cannot be seen by naked eyes. Upon taking the specification and the brightness of the whole display into consideration, the size of the gap G is in a range between 20 mm and 50 mm. In this embodiment, the brightness of the display is 97% of the brightness of the light source 31.

In this embodiment, the user may control the brightness and the transparency of the light modulation module 20 through a manual instruction U2. For example, through the manual instruction U2, the light modulation unit 40 may be switched to be in a transparent state or a non-transparent state, and the light source 31 may be switched to be turned on or off. When the light modulation unit 40 is in the transparent state, the user can see through the object behind the LCD panel 10, so that the LCD panel 10 is served as a transparent display. When the light modulation unit 40 is in the non-transparent state, the light modulation unit 40 is not transparent and served as a light reflection sheet, thereby increasing the display brightness. Moreover, through a control command U1 of the LCD panel 10, the chroma of the LCD panel 10 can be controlled to have different display scenarios. In this embodiment, the LCD panel 10 has at least eight display scenarios which are presented in Table 1 below. However, it is understood that, the display scenarios exemplified in Table 1 are only provided for illustrative purposes, not limitations to the instant disclosure.

TABLE 1

| | Light | Light modulation | Chroma of the LCD |
|---|---|---|---|
| | source | unit | panel |
| Mode 1 | Off | Transparent | Low chroma |
| Mode 2 | Off | Transparent | High chroma |
| Mode 3 | On | Transparent | Low chroma |
| Mode 4 | On | Transparent | High chroma |
| Mode 5 | Off | Non-transparent | Low chroma |
| Mode 6 | Off | Non-transparent | High chroma |
| Mode 7 | On | Non-transparent | Low chroma |
| Mode 8 | On | Non-transparent | High chroma |

For example, when the LCD panel 10 is originally in the mode 1 where the ambient light is insufficient, the user can switch the mode of the LCD panel 10 to be mode 2. Therefore, in the transparent display mode, the LCD panel 10 provides a better readability for the user. Alternatively, in some embodiments, when important information is to be displayed, the mode of the LCD panel 10 can be switched to be mode 8, so that the LCD panel 10 can provide a higher readability for the user. Therefore, the LCD panel 10 can provide the user with modulable and various display modes.

Moreover, in some embodiments, the first control unit 51 and the second control unit 53 may be packaged in the same chip. Therefore, the first control unit 51 and the second control 53 have common signal receiving/emitting ends while the chroma of the LCD panel 10 and the brightness/transparency of the light modulation module 20 can be controlled independently.

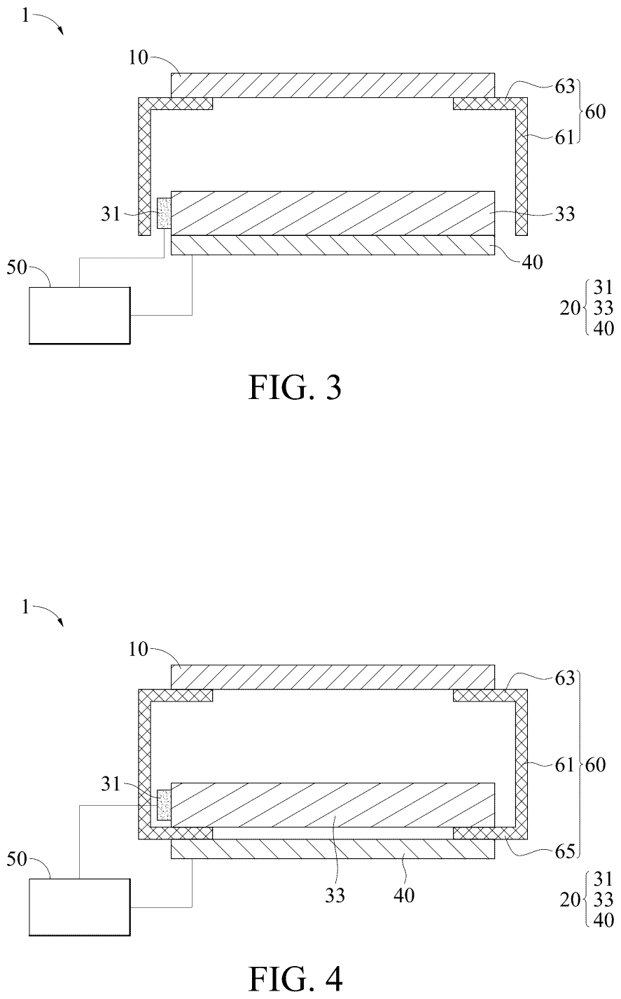

FIG. 3 illustrates a cross-sectional view of a modulable transparent display according to a second embodiment of the instant disclosure. FIG. 4 illustrates a cross-sectional view of a modulable transparent display according to a third embodiment of the instant disclosure. As shown in FIG. 3 and FIG. 4 as well as FIG. 1, the spacer 60 may be different structures which may be utilized in the modulable transparent display 1 according to practical product specification and demands. For example, as shown in FIG. 1, the spacer 60 is assembled with a side edge of the LCD panel 10 and a side edge of the light guiding plate 33, so that the LCD panel 10 and the light guiding plate 33 are directly separated by the spacer 60. Moreover, as shown in FIG. 3, the spacer 60 comprises a first assembling portion 61 and a second assembling portion 63. The first assembling portion 61 is assembled with the side edge of the light guiding plate 33 to shield the light source 31, the second assembling portion 63 extends from one of two ends of the first assembling portion 61 along a direction substantially perpendicular to an extension direction of the first assembling portion 61, and the second assembling portion 63 is assembled with a side edge of the LCD panel 10, so that the first assembling portion 61 and the second assembling portion 63 can be together formed as a portion of the frame of the display. In this embodiment, the description “substantially perpendicular to” refers to a visual determination through naked eyes, which allows the angle between the components to be not completely perpendicular to each other. In other words, in the second embodiment, the LCD panel 10 may be disposed on the second assembling portion 63.

Moreover, as shown in FIG. 4 as well FIG. 3, as compared with the spacer 60 of the second embodiment, the spacer 60 of the third embodiment further comprises a third assembling portion 65. The third assembling portion 65 and the second assembling portion 63 respectively extend from the two ends of the first assembling portion 61. The third assembling portion 65 is substantially parallel to the second assembling portion 63, and the third assembling portion 65 contacts an edge portion of a bottom portion of the light guiding plate 33. It is understood that, the structure of the spacer 60 in the embodiments are provided as illustrative purposes, but not limitations to the instant disclosure. As long as the configuration of the spacer 60 can allow the gap G to be maintained and does not shield the light guided by the light guiding plate 33 toward the LCD panel 10, the spacer 60 with various structures can be applied. In other words, in the third embodiment, the LCD panel 10 and the light modulation unit 40 may be respectively disposed on the second assembling portion 63 and the third assembling portion 65.

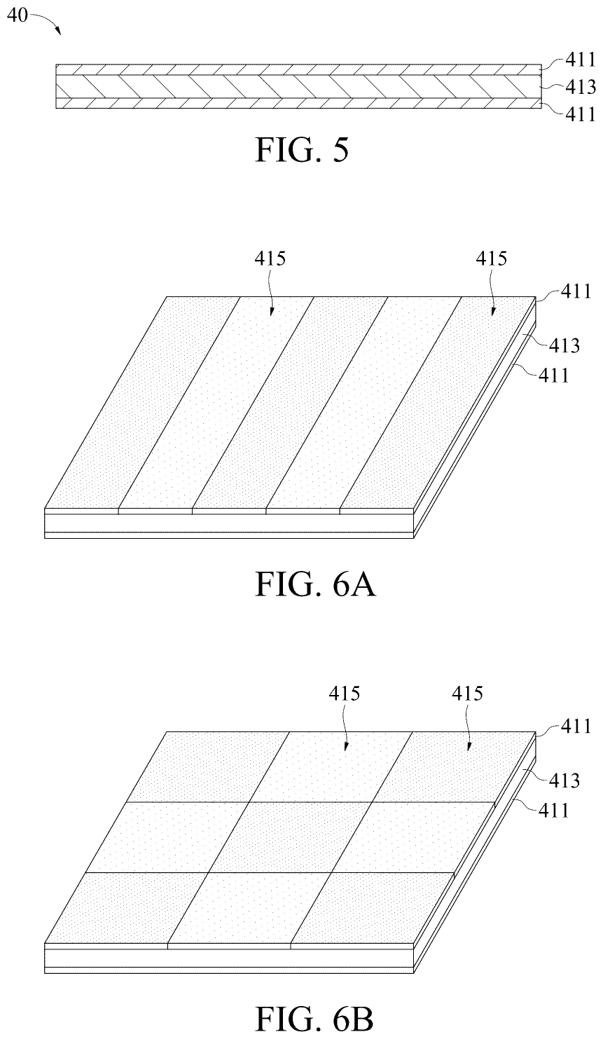

FIG. 5 illustrates an enlarged cross-sectional view of a light modulation unit according to one embodiment of the instant disclosure. As shown in FIG. 5, the light modulation unit 40 comprises a liquid crystal layer 413 and a transparent conductive layer 411. The second control unit 53 is electrically connected to the transparent conductive layer 411 to apply different voltages on the transparent conductive layer 411, so that the liquid crystal rotation angle of the liquid crystal layer 413 can be controlled. In this embodiment, the light modulation unit 40 may be a sandwich structure in which the liquid crystal layer 413 is sandwiched by two transparent conductive layers 411. In this embodiment, the liquid crystal layer 413 may be a polymer-dispersed liquid crystal (PDLC) layer or a polymer network liquid crystal (PNLC) layer.

In this embodiment, the transparency modulation signal T is a voltage signal. By applying different driving voltages on the transparent conductive layer 411, the liquid crystal rotation angle of the liquid crystal layer 413 can be controlled, so that the transmittance of the liquid crystal layer 413 can be controlled. More specifically, in some embodiments, for example, when the driving voltage is equal to or more than 80% of the nominal voltage, the transmittance of the liquid crystal layer 413 is equal to or more than 70%, so that the light modulation unit 40 becomes transparent. For example, when the driving voltage is equal to or less than 60% of the nominal voltage, the transmittance of the liquid crystal layer 413 is equal to or less than 50%, so that the light modulation unit 40 becomes non-transparent.

Moreover, in the case that the driving voltage is equal to or greater than 80% of the nominal voltage and the transmittance of the liquid crystal layer 413 is equal to or greater than 70%, the brightness of the display can be modulated by turning the light source 31 on or off. For example, when the light source 31 is turned on with 100% brightness, the user can see the light modulation unit 40 to be semi-transparent in the case that the driving voltage is 80% or 100% of the nominal voltage. For example, when the light source 31 is turned on with 50% brightness, the user can see the light modulation unit 40 to be semi-transparent in the case that the driving voltage is 100%, while the user can see the modulable transparent display 1 to be transparent in the case that the driving voltage is 80%. When the light source 31 is turned off, the user can see the light modulation unit 40 to be transparent in the case that the driving voltage is 80% or 100% of the nominal voltage. Therefore, in addition to the display scenarios in Table 1, the transparency of the light modulation unit 40 can further be controlled by adopting the light source 31 with different brightness, thereby allowing the modulable transparent display 1 to provide various display scenarios. In this embodiment, it is understood that, under scenarios that the light source 31 is turned off, the modulable transparent display 1 is a transparent display.

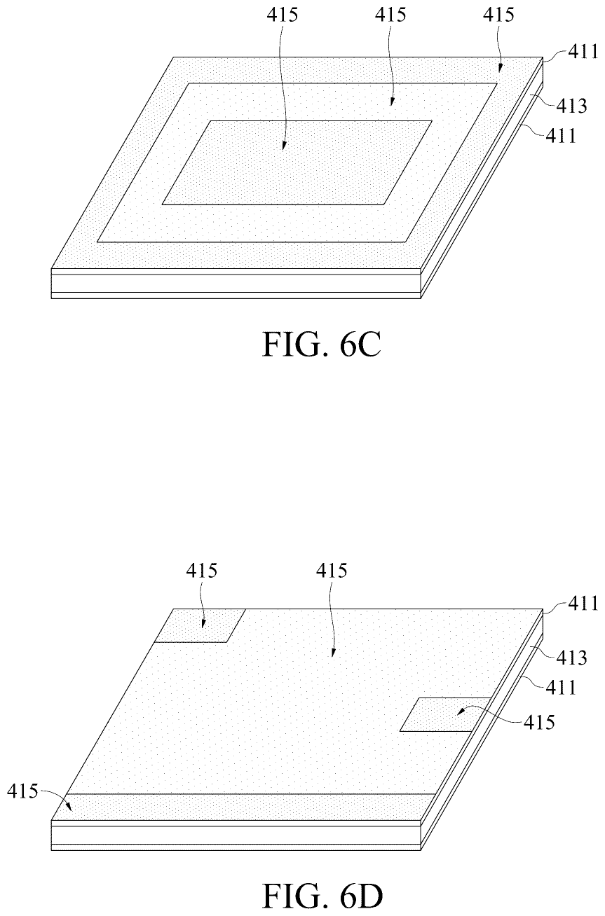

FIG. 6A to FIG. 6D illustrate schematic views of controlled regions of various embodiments of the instant disclosure. As shown in FIG. 6A to FIG. 6D as well as FIG. 5, the transparent conductive layer 411 may be divided into a plurality of control regions 415 by using laser cutting techniques, and each of the control regions 415 is controlled by the second control unit 53. Therefore, the transmittance of the liquid crystal layer 413 corresponding to the control region 415 can be controlled. Therefore, parts of the light modulation unit 40 may be transparent, semi-transparent, or non-transparent.

The dividing manner of the control regions 415 may be adjusted according to practical specification and demands. For example, in some embodiments, as shown in FIG. 6A, the control regions 415 are of a strip arrangement in which the control regions 415 are arranged as several bars which are further arranged side-by-side. Alternatively, in some embodiments, as shown in FIG. 6B, the control regions 415 are of a grid arrangement. Alternatively, in some embodiments, as shown in FIG. 6C, the control regions 415 are of a concentric arrangement (concentric circular or rectangular rings). Moreover, as shown in FIG. 6D, in some embodiments, certain control regions 415 may be configured according to the display specification. For example, the control region 415 may be provided as a region for shielding certain information. Moreover, through the addressable control of the display, more options of display scenarios can be provided.

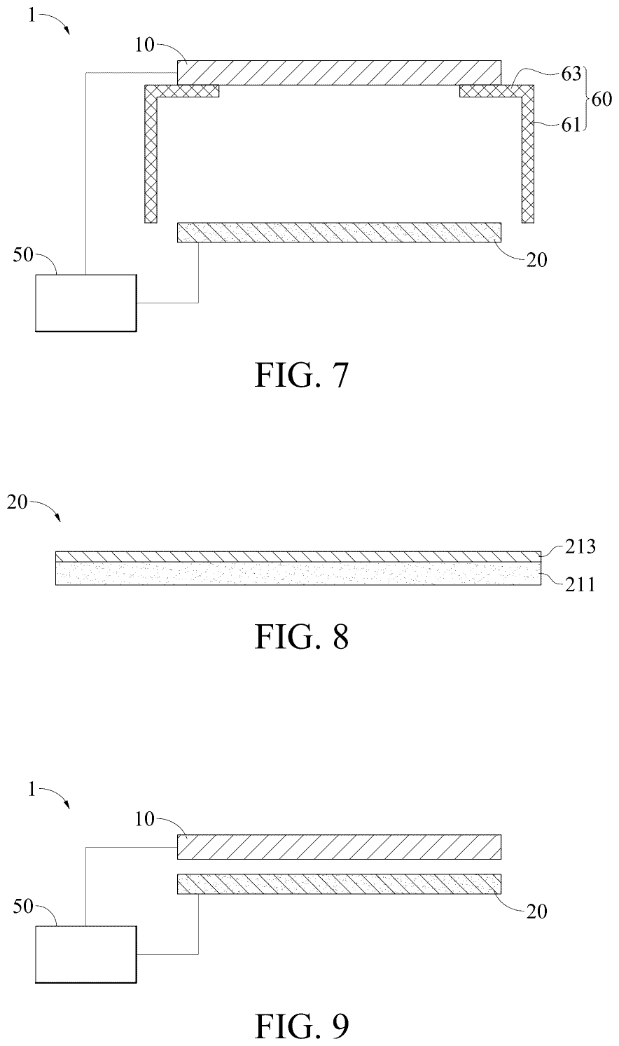

FIG. 7 illustrates a cross-sectional view of a modulable transparent display according to a fourth embodiment of the instant disclosure. FIG. 8 illustrates an enlarged cross-sectional view of a light modulation module according to one embodiment of the instant disclosure. As shown in FIG. 7, the light modulation module 20 may be configured as a surface light source. As shown in FIG. 8, the light modulation module 20 comprises a transparent substrate 211 and an organic light-emitting diode (OLED) array 213 on the transparent substrate 211. The transparent substrate 211 may be a sheet member, a plate member, or a thin film. In this embodiment, the OLED array 213 is directly provided as the back surface light source of the modulable transparent display 1. Alternatively, in some embodiments, the OLED array 213 is merely served as the light source. Moreover, as compared with the pixel arrangement of the OLED display known to the inventor, the pixel arrangement of the OLED array 213 in the modulable transparent display 1 can be less compacted, and as compared with the circuit design of the OLED display known to the inventor, the circuit design of the OLED array 213 in the modulable transparent display 1 can be much easier, thereby reducing the manufacturing costs of the display. Moreover, in some embodiments, the second control unit 53 directly controls the brightness of the OLED array 213 to allow the display to be transparent, semi-transparent, or non-transparent.

FIG. 9 illustrates a cross-sectional view of a modulable transparent display according to a fifth embodiment of the instant disclosure. As shown in FIG. 9, in some embodiments, in the case that the OLED array 213 is served as the surface light source, optical microstructures needed for the light guiding plate 33 in the first embodiment to the third embodiment are not presented, and thus the spacer 60 can be omitted, thereby further thinning the overall thickness of the modulable transparent display 1. However, it is understood that, the spacer 60 can control the display to be transparent/semi-transparent/non-transparent through different parameters to achieve a more delicate performance.

Furthermore, like the embodiments shown in FIG. 6A to FIG. 6D, different control regions 415 can be defined on the OLED array 213 according to the embodiments shown in FIG. 7 and FIG. 9. However, in these embodiments, the defining of the control regions 415 is not achieved by cutting the transparent conductive layer with laser cutting techniques; instead, the control regions 415 are defined through program settings.

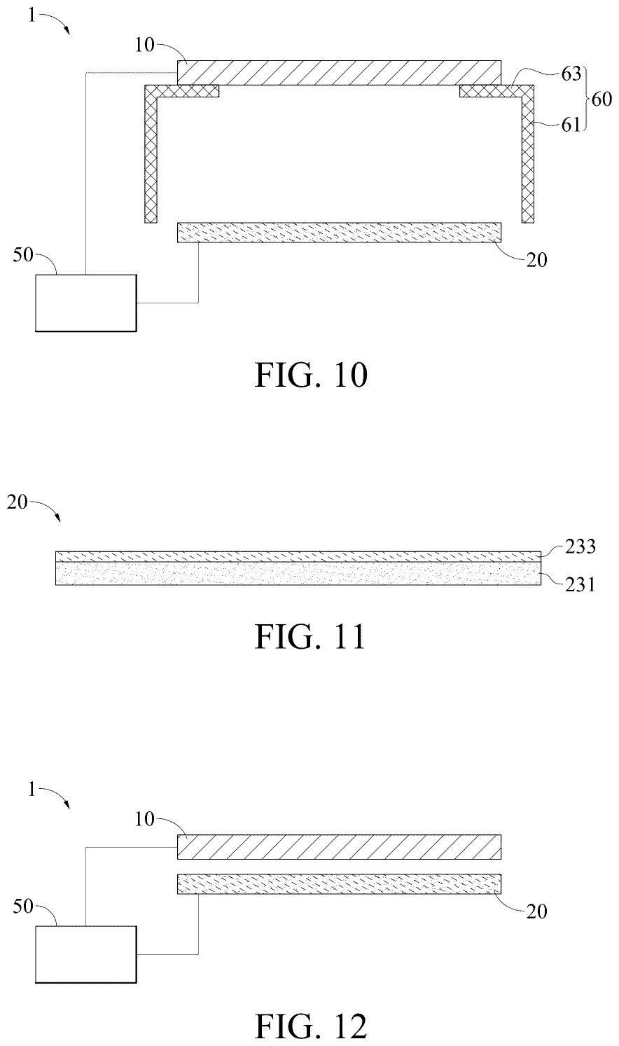

FIG. 10 illustrates a cross-sectional view of a modulable transparent display according to a sixth embodiment of the instant disclosure. FIG. 11 illustrates an enlarged cross-sectional view of a light modulation module according to another embodiment of the instant disclosure. As shown in FIG. 10, the light modulation module 20 comprises a transparent substate 231 and a mini LED array/micro LED array 233 on the transparent substrate 231. In this embodiment, in order to maintain the transparent/non-transparent configuration, the circuit boards for being assembled with the mini LED array or the micro LED array which are known to the inventor have to be manufactured by using transparent materials. As the embodiments shown in FIG. 7 and FIG. 9, the mini LED array or the micro LED array 233 may be served as the back surface light source, and the second control unit 53 directly controls the brightness of the mini LED array or the micro LED array 233 to allow the display to be transparent/semi-transparent/non-transparent.

FIG. 12 illustrates a cross-sectional view of a modulable transparent display according to a seventh embodiment of the instant disclosure. As shown in FIG. 12, in some embodiments, in the case that the mini LED array or the micro LED array 233 is served as the surface light source, optical microstructures needed for the light guiding plate 33 in the first embodiment to the third embodiment are not presented, and thus the spacer 60 can be omitted, thereby further thinning the overall thickness of the modulable transparent display 1. However, it is understood that, the spacer 60 can control the display to be transparent/semi-transparent/non-transparent through different parameters to achieve a more delicate performance.

Furthermore, like the embodiments shown in FIG. 6A to FIG. 6D, different control regions 415 can be defined on the mini LED array or the micro LED array 233. However, in these embodiments, the defining of the control regions 415 is not achieved by cutting the transparent conductive layer with laser cutting techniques; instead, the control regions 415 are defined through program settings.

According to one or some embodiments, by using the LCD panel which adopts more matured manufacturing processes and has cheaper prices in the modulable transparent display 1, not only the costs of the display can be greatly reduced and the duration of the display can be increased, but also, through the configuration of the light modulation module 20, the display scenario of the LCD panel 10 can be modulated. According to some embodiments, an additional light source may be provided for the LCD panel 10 to address the issue of insufficient lightening of the LCD panel 10 under ambient light, and according to some other embodiments, the LCD panel 10 may be switched to a non-transparent mode to increase the display performance. Hence, the user can select and control the operation mode of the display according to the application scenarios, thereby allowing the display to provide various applications.

Although the instant disclosure has been disclosed as above by way of embodiments, the embodiments are not intended to limit the scope of the instant disclosure, and persons having ordinary skills in the art may make some changes and modifications without departing from the spirit and scope of the instant disclosure, and therefore the scope of protection of the instant disclosure shall be subject to the scope of the instant disclosure as defined in the appended claims.

1. A modulable transparent display comprising:
a liquid crystal display (LCD) panel;
a light modulation module having a brightness and a transparency, wherein the light modulation module comprises a light source, a light guiding plate, and a light modulation unit, the light source is at a side edge of the light guiding plate, the light guiding plate is between the light modulation unit and the LCD panel to guide a light emitted from the light source toward the LCD panel, and the light modulation unit and the light source are controlled by the second control unit, respectively; and
a control module electrically connected to the LCD panel and the light modulation module, wherein the control module comprises a first control unit and a second control unit, the first control unit is adapted to provide a display signal for the LCD panel, and the second control unit is adapted to provide a control signal for the light modulation module to control the brightness and the transparency;
wherein the light modulation unit comprises a liquid crystal layer and a transparent conductive layer, and the second control unit is electrically connected to the transparent conductive layer to control a liquid crystal rotation angle of the liquid crystal layer.

2. The modulable transparent display according to claim 1, further comprising a spacer, wherein a gap is between the light modulation module and the LCD panel, the spacer is between the light modulation module and the LCD panel, and the gap is maintained through the spacer.

3. The modulable transparent display according to claim 1, wherein the light modulation module comprises a transparent substrate and a light-emitting array on the transparent substrate.

4. The modulable transparent display according to claim 3, wherein the light-emitting array comprises one of an organic light-emitting diode (OLED) array, a mini light-emitting diode (LED) array, or a micro LED array.

5. The modulable transparent display according to claim 3, wherein the light-emitting array is defined as a plurality of control regions, and each of the control regions is controlled by the second control unit.

6. (canceled)

7. The modulable transparent display according to claim 61, wherein a size of the gap is at least greater than 20 mm.

8. The modulable transparent display according to claim 7, wherein the size of the gap is in a range between 20 mm and 50 mm.

9. The modulable transparent display according to claim 61, wherein the spacer is assembled with a side edge of the LCD panel and the side edge of the light guiding plate.

10. The modulable transparent display according to claim 2, wherein the spacer comprises a first assembling portion and a second assembling portion, the first assembling portion is assembled with the side edge of the light guiding plate to shield the light source, the second assembling portion extends form one of two ends of the first assembling portion along a direction substantially perpendicular to an extension direction of the first assembling portion, and the second assembling portion is assembled with a side edge of the LCD panel.

11. The modulable transparent display according to claim 10, wherein the spacer further comprises a third assembling portion, the third assembling portion and the second assembling portion respectively extend from the two ends of the first assembling portion, the third assembling portion is substantially parallel to the second assembling portion, and the third assembling portion contacts an edge portion of a bottom portion of the light guiding plate.

12. (canceled)

13. The modulable transparent display according to claim 121, wherein the liquid crystal layer is a polymer-dispersed liquid crystal (PDLC) layer or a polymer network liquid crystal (PNLC) layer.

14. The modulable transparent display according to claim 121, wherein the transparent conductive layer is divided into a plurality of control regions, and each of the control regions is controlled by the second control unit.

15. The modulable transparent display according to claim 14, wherein the control regions are of a strip arrangement, a grid arrangement, or a concentric arrangement.

16. The modulable transparent display according to claim 2, wherein the light modulation module comprises a transparent substrate and a light-emitting array on the transparent substrate.

17. The modulable transparent display according to claim 16, wherein the light-emitting array comprises one of an organic light-emitting diode (OLED) array, a mini light-emitting diode (LED) array, or a micro LED array.

18. The modulable transparent display according to claim 16, wherein the light-emitting array is defined as a plurality of control regions, and each of the control regions is controlled by the second control unit.
